(19) United States
(12) Patent Application Publication
(10) Pub. No.: US 2024/0424568 A1
(43) Pub. Date: Dec. 26, 2024

(54) NON-UNIFORM BEAMS FOR TAILORING HEAT DEPOSITION IN LASER-ASSISTED ADDITIVE MANUFACTURING

(71) Applicant: Xerox Corporation, Norwalk, CT (US)

(72) Inventors: Dogan Timucin, Santa Cruz, CA (US); Patrick Y. Maeda, San Jose, CA (US); Adrian Lew, Stanford, CA (US)

(21) Appl. No.: 18/213,681

(22) Filed: Jun. 23, 2023

(51) Int. Cl. B22F 12/41; B22F 10/22; B22F 12/53; B22F 12/90; B33Y 10/00; B33Y 30/00; B33Y 50/02

(52) U.S. Cl. CPC B22F 12/41; B22F 10/22; B22F 12/53; B22F 12/90; B33Y 10/00; B33Y 30/00; B33Y 50/02; B22F 2998/10

(57) ABSTRACT

Techniques for laser-assisted additive manufacturing are disclosed. An example three-dimensional (3D) printer includes a platen having a surface to support a part during fabrication of the part. The 3D printer also includes an ejector head arranged above the surface of the platen. The ejector head is to eject build material toward the surface of the platen to fabricate the part. The 3D printer also includes a laser heating system to heat a target portion of the part during the fabrication of the part to improve a bond between the build material and the target portion of the part. The laser heating system includes a laser to output a laser beam that exhibits a non-gaussian beam profile.

### TECHNICAL FIELD

Implementations of the present disclosure relate to techniques for additive manufacturing and, more particularly, to optical systems for laser-assisted three-dimensional (3D) printers, such as drop-on-demand 3D metal object printers.

### BACKGROUND

Three-dimensional printing, also known as additive manufacturing, is a process of making a three-dimensional solid object from a digital model of virtually any shape. Many three-dimensional printing technologies use an additive process in which an additive manufacturing device ejects drops or extrudes ribbons of a build material to form successive layers of the part on top of previously deposited layers. These technologies are used to construct three-dimensional objects with a variety of shapes and features. This additive manufacturing method is distinguishable from traditional object-forming techniques, which mostly rely on the removal of material from a work piece by a subtractive process, such as cutting or drilling.

Recently, some 3D object printers have been developed that eject drops of molten metal from one or more ejectors to form 3D metal objects. These printers have a source of solid metal, such as a roll of wire, macro-sized pellets, or metal powder, and the solid metal is fed into a heated receptacle of the printer where the solid metal is melted and the melted metal fills the receptacle. The receptacle is made of non-conductive material around which an electrical wire is wrapped to form a coil. An electrical current is passed through the coil to produce an electromagnetic field that causes a drop of melted metal at the nozzle of the receptacle to separate from the melted metal within the receptacle and be propelled from the nozzle. A platform is configured to move in a X-Y plane parallel to the plane of the platform by a controller that operates actuators so that melted metal drops ejected from the nozzle form metal layers of an object on the platform. The controller operates another actuator to alter the position of the ejector or platform to maintain an appropriate distance between the ejector and an existing layer of the metal object being formed. This type of metal drop ejecting printer is called a magnetohydrodynamic (MHD) printer.

While magnetohydrodynamic printing has made great progress, the parts fabricated from conventional magnetohydrodynamic printing systems often exhibit inconsistencies with respect to build strength, adhesion, porosity, surface finish, cracking, fractures, Z-height errors, and the like. In view of the foregoing, secondary or post-printing processes, such as machining and finishing, are often implemented to address the inconsistencies in the objects fabricated from conventional magnetohydrodynamic printing systems. These post-printing processes, however, greatly reduce productivity and correspondingly increase the cost of fabricating the part via magnetohydrodynamic printing.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments. Like numerals indicate like elements

FIG. 1 depicts a schematic cross-sectional view of a 3D printer 100, in accordance with certain aspects of the present disclosure.

FIG. 2A depicts a Gaussian beam profile in accordance with certain aspects of the present disclosure.

FIG. 2B depicts a ring profile in accordance with certain aspects of the present disclosure.

FIG. 2C depicts a hollow-point ring profile in accordance with certain aspects of the present disclosure.

FIG. 2D depicts an azimuthally variable beam profile in accordance with certain aspects of the present disclosure.

FIG. 3 is a graph of beam magnitude as a function of distance from the beam center in accordance with certain aspects of the present disclosure.

FIG. 4A is a graph of substrate temperature at the beam center as a function of time in accordance with certain aspects of the present disclosure.

FIG. 4B is a graph of substrate temperature at the beam edge as a function of time in accordance with certain aspects of the present disclosure.

FIG. 5A is the temperature at the surface of the substrate at time t=τ in accordance with certain aspects of the present disclosure.

FIG. 5B is the temperature at the surface of the substrate at time t=1.25τ in accordance with certain aspects of the present disclosure.

FIG. 6 is a process flow diagram of an example method 600 of operating a 3D printer in accordance with certain aspects of the present disclosure.

### DETAILED DESCRIPTION

Aspects of the present disclosure provide various techniques for laser-assisted 3D printing using, for example, liquid metal jetting printers. In liquid metal jetting, a single droplet deposited on a solid of the same material serves as the basic building block for fabrication by precise, droplet-wise deposition. One type of liquid metal jetting printer is a magnetohydrodynamic (MHD) printer, which is suitable for depositing liquid metal layer upon layer to form a 3D metallic object. In an MHD printer, an electrical current flows through a metal coil, which produces time-varying magnetic fields that induce eddy currents within a reservoir filled with a liquid metal alloy. Coupling between magnetic and electric fields within the liquid metal results in a Lorentz force.

It should be appreciated that forming structures with molten metal droplets is a complex thermo-fluidic process that involves re-melting, coalescence, cooling, and solidification. Voids and cold lap (lack of fusion) are caused by poor re-melting and insufficient metallurgical bonding under inappropriate temperatures at the interface formed between the molten metal droplets and previously deposited material or substrates. This interfacial temperature is primarily a function of the droplet temperature and the surface temperature of the previously deposited material or substrate. Obtaining and retaining accurate part shape and Z-height are also negatively impacted by the same factors. An interfacial temperature that is too low results in the formation of voids and cold laps from insufficient re-melting and coalescence. Conversely, if the interfacial temperature is too high, the new droplets flow away from the surface of previously deposited material before solidification, which leads to the malformation of part shape and Z-height error.

The interfacial temperature can be managed by controlling the initial droplet temperature, the build part surface temperature, the build plate temperature, drop frequency, and part Z-height. These factors can be controlled at some level through process parameter optimization, but the thermal processes involved may be too slow to keep up with the changes and dynamics that occur during part printing that can result in unacceptable interfacial temperatures.

To better manage the interfacial temperature, the 3D printer can be equipped with a laser heating system, which is used to modify the interfacial temperatures of a substrate to control grain size, growth, and/or structure of the metal forming the part 118. Such a laser heating system can be operated to improve build strength, adhesion, porosity, and/or surface finish, and preventing cracks and fractures in the article.

However, traditional beam profiles (e.g., Gaussian) tend to produce a uni-modal temperature rise that quickly dissipates due to rapid heat conduction in the metal. Such a beam profile also deposits heat immediately under the incoming droplet, which is where it may be least needed. The present disclosure provides techniques to improve the pattern of heat deposition, which in turn promotes a stronger metallurgical bond between the substrate and the new droplet. The pattern of heat deposition may be improved by tailoring the light intensity profile of the emitted laser light, referred to herein as the beam profile. For example, the beam profile may be ring shaped to raise the temperature on the substrate in a ring pattern that is roughly the same diameter as the incoming droplet. This pattern of heat deposition, when combined with the heat delivered to the substrate at the center of the ring by the incoming hot droplet produces a much larger interface area of elevated temperature, which in turn promotes a stronger metallurgical bond between the substrate and the new droplet. Various beam profiles can be realized using suitable optical components used in the optical train that would otherwise deliver a traditional Gaussian laser beam to the metal surface. The ring can be continuous or can include a number of individual peaks (“lobes”) of light intensity (an azimuthally inhomogeneous beam). The ring radius, as well as the number and size of the lobes can be adjusted for optimal performance.

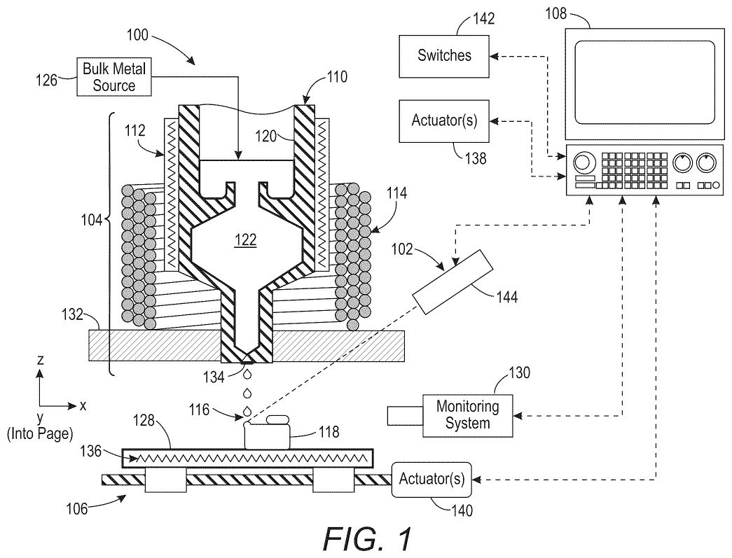

FIG. 1 shows an exemplary 3D object printer 100 with a laser heating system 102. The 3D object printer 100 is a liquid metal jetting printer, such as a magnetohydrodynamic (MHD) printer. However, the techniques described herein may be used in any additive manufacturing device that uses a laser heating system, including those that use non-metal build materials.

The 3D object printer 100 includes an ejector head 104 and a build platform 106. As used herein, the term “ejector head” refers to the housing and components of a 3D object printer that melt, eject, and regulate the ejection of melted drops of build material for the production of 3D objects. The ejector head 104 includes a body 110 (which may also be referred to as a pump chamber), one or more heating elements 112, and one or more metallic coils 114, which are operably coupled with one another. The heating elements 112 are at least partially disposed about the body 110, and the metallic coils 114 are at least partially disposed about the body 110 and/or the heating elements 112. The body 110 has an inner surface 120 defining an inner vessel 122 thereof. The body 110 defines a nozzle 124 disposed at a first end of the body 110, which extends through an opening defined in a heat shield 132. As used herein, the term “nozzle” means a structure defining an orifice that is fluidically connected to a volume or vessel containing melted build material and that is configured for the expulsion of melted drops of build material from the volume or vessel. The head shield 132 is arranged between the body 110 of the ejector head 104 and the build platform 106. The nozzle 124 has an orifice 134 at an end of the portion thereof that extends through the opening of the heat shield 132, via which the ejector head 104 ejects droplets of build material onto a substrate 116 to fabricate a part 118. As used herein, the term “part” means an object of manufacture made with a 3D printer.

The build platform 106 comprises at least a platen 128, such as heated platen 128 having a heating element 136, onto which the ejector head 104 ejects droplets of build material to form the part 118. As used herein, the substrate 116 refers the surface upon which the ejector head 104 ejects new droplets of build material. Thus, at least for an initial layer of build material, the substrate 116 refers to a top surface of the platen 128 and, for subsequent layers of material, the substrate 116 refers to a surface of the previously deposited build material and/or a surface of the partially fabricated part 118.

In an exemplary operation of the 3D object printer 100, a build material (e.g., metal) from a source 126 of bulk material (e.g., bulk metal) is directed to the inner vessel 122 of the body 110. As used herein, the term “bulk material” means build material available in aggregate form, such as metal wire of a commonly available gauge, macro-sized metal pellets, and metal powder. As used herein, the term “vessel” means a hollow volume having a receptacle configured to hold a liquid or solid substance. In some embodiments, the build material includes one or more metals and/or alloys thereof. The heating elements 112 at least partially melt the build material contained in the inner vessel 122 of the body 110. In particular, the build material may be a solid metal, and the heating elements 112 heat the body 110 and thereby heat the metal from a solid to a liquid (e.g., molten metal). As used herein, the term “metal” means a metal as defined by the periodic chart of elements or alloys formed with these metals. Illustrative metal build materials include, but are not limited to, aluminum, aluminum alloys, brass, bronze, chromium, cobalt-chrome alloys, copper, copper alloys, iron alloys (Invar), nickel, nickel alloys (Inconel), nickel-titanium alloys (Nitinol), stainless steel, tin, titanium, titanium alloys, gold, silver, molybdenum, tungsten, or the like, or alloys thereof, or any combination thereof.

The metallic coils 114 are coupled with a power source (not shown) configured to facilitate the ejection of melted droplets of the molten build material onto the substrate 116. In particular, the metallic coils 114 and the power source coupled therewith are configured to generate a magnetic field that generates an electromotive force within the body 110 that generates an induced electrical current in the molten metal disposed in the body 110. The magnetic field and the induced electrical current in the molten metal creates a radially inward force on the liquid metal, known as a Lorentz force, which creates a pressure at the nozzle 124. The pressure at the nozzle 124 expels the molten metal through the orifice 134 and out of the nozzle 124 toward the substrate 116 and/or the build platform 106 in the form of one or more droplets to thereby form at least a portion of the part 118.

With continued reference to FIG. 1, the 3D object printer 100 includes a computing system 108. The computing system 108 at least includes a processor and memory (not shown). The processor is configured to execute instructions to operate the computing system 108 and/or the 3D object printer 100 to enable the features, functionality, characteristics and/or the like as described herein. The processor may include one or more processors which may operate in parallel or otherwise in concert with one another. It will be recognized by those of ordinary skill in the art that a “processor” includes any hardware system, hardware mechanism or hardware component that processes data, signals or other information. Accordingly, the processor may include a system with a central processing unit, graphics processing units, multiple processing units, dedicated circuitry for achieving functionality, programmable logic, or other processing systems. The memory is configured to store data and program instructions that, when executed by the processor, enable the computing system 108 and/or the 3D object printer 100 to perform various operations described herein. The memory may be of any type of device capable of storing information accessible by the processor, such as a memory card, ROM, RAM, hard drives, discs, flash memory, or any of various other computer-readable medium serving as data storage devices, as will be recognized by those of ordinary skill in the art.

The computing system 108 is operably and/or communicably coupled with any one or more of the components of the 3D object printer 100. Particularly, the computing system 108 is at least operably and/or communicably coupled with one or more switches 142 configured to operate the metallic coils 114 to eject melted droplets of the build material onto the substrate 116, as discussed above (e.g., by connecting and disconnecting the metallic coils 114 from the power source).

Additionally, the computing system 108 is operably and/or communicably coupled with actuators 138, 140 configured to move certain components of the 3D object printer 100 independently from one another or together with one another. Particularly, in some embodiments, any one or more components of the 3D object printer 100 may move independently with respect to one another. For example, in some embodiments, the ejector head 104 and the platen 128 of the build platform 106 (or any other components of the 3D object printer 100) are configured move independently from one another along an X-axis, a Y-axis, and/or a Z-axis. Similarly, any two or more components of the 3D object printer 100 may be coupled with one another such that the two or more components move with one another. For example, the ejector head 104 and the laser heating system 102 may be coupled with one another via a mount (not shown) such that the movement or translation of the ejector head 104 along the X-axis, the Y-axis, and/or the Z-axis results in a corresponding movement or translation of the laser heating system 102 along the X-axis, the Y-axis, and/or the Z-axis, respectively.

In some embodiments, the computing system 108 is configured to the operate actuator(s) 138 to move the ejector head 104 at least along the Z-axis. Particularly, in some embodiments, the ejector head 104 is movably mounted within Z-axis tracks or a similar mechanism (not shown) configured for movement of the ejector head 104 (and any other components fixedly mounted thereto) relative to the platen 128 of the build platform 106. The actuator(s) 138 are configured to move the ejector head 104 along the Z-axis by way of the Z-axis tracks. The computing system 108 operates these actuator(s) 138 to maintain an appropriate distance in the Z-direction between the orifice 134 of the nozzle 124 and the substrate 116. In some embodiments, the ejector head 104 is similarly configured to also move along the X-axis and/or the Y-axis.

In some embodiments, the computing system 108 is configured to the operate actuator(s) 140 to move at least the platen 128 of the build platform 106 along an X-Y plane defined by the X-axis and the Y-axis. Particularly, in some embodiments, the platen 128 is movably mounted within X-axis and Y-axis tracks or similar mechanisms (not shown) configured for movement of the platen 128 (and any other components fixedly mounted thereto) relative to the ejector head 104. The actuator(s) 140 are configured to move the platen 128 of the build platform 106 along the X-Y plane by way of the X-axis and Y-axis tracks. The computing system 108 operates these actuator(s) 140 to provide the necessary X-Y positioning of the substrate 116 with respect to the orifice 134 of the nozzle 124. In some embodiments, the platen 128 of the build platform 106 is similarly configured to also move along the Z-axis.

To fabricate the part 118, the computing system 108 may operate the actuator(s) 138 to position the orifice 134 of the nozzle 124 over the substrate 116 at a defined distance from in the Z-direction the substrate 116 (e.g., between 4 mm and 8 mm). Additionally, the computing system 108 operates the switches 142 to cause the nozzle 124 to eject molten metal droplets of onto the substrate 116 to begin forming the part 118. In concert with ejecting the molten metal droplets, the computing system 108 also operates the actuators 140 to move the platen 128 of the build platform 106 in the X-Y plane to form layers of melted metal on the substrate 116 to form the part 118. As each layer of metal is deposited onto the substrate 116, the computing system 108 operates the actuator(s) 138 to maintain an appropriate distance in the Z-direction between the orifice 134 and the substrate 116. (e.g., between 4 mm and 8 mm). In some embodiments, the computing system 108 may similarly move the ejector head 104 in the X-Y plane or move the move the platen 128 along the Z-axis.

The computing system 108 may access data from external sources to facilitate the fabrication the part 118. In general, a three-dimensional model or other digital model of the part 118 that is to be fabricated is stored in a memory operatively connected to the computing system 108. The computing system 108 may be configured to access the digital model through a server or the like, a remote database in which the digital model is stored, or a computer-readable medium in which the digital model is stored. The computing system 108 (or another processor or controller) processes the digital model to generate machine instructions for execution by the computing system 108 in a known manner to operate the components of the 3D object printer 100 to form the part 118 corresponding to the model. The generation of the machine instructions can include the production of intermediate models, such as when a CAD model of the device is converted into an STL data model, a polygonal mesh, or other intermediate representations, which in turn can be processed to generate machine instructions, such as g-code, for fabrication of the object by the 3D object printer 100. As used herein, the term “machine instructions” means computer language commands that are executed by a computer, microprocessor, or controller to operate components of a 3D object additive manufacturing system. The computing system 108 executes the machine instructions to control the ejection of the melted metal drops from the nozzle 124, to control the positioning of the platen 128, and to control the positioning of the ejector head 104.

The 3D object printer 100 may also include a monitoring system 130. The monitoring system 130 may, for example, include one or more illuminators and/or one or more sensors (not shown) configured to measure droplet temperatures, build part temperatures, build plate temperatures, substrate temperatures, build part shape, build part Z-height, droplet size, droplet rate, or the like, or any combination thereof. Illustrative illuminators include, but are not limited to, lasers, LEDs, lamps of various types, fiber optic light sources, or the like, or combinations thereof. Illustrative sensors include, but are not limited to, pyrometer, thermistors, imaging cameras, photodiodes, or the like, or combinations thereof. In some embodiments, the monitoring system 130 is configured to communicate with the computing system 108 to provide feedback measurements. In some embodiments, the computing system 108 operates the components of the 3D object printer 100 with reference to the feedback measurements in a closed-loop manner.

As mentioned above, the 3D object printer 100 also includes a laser heating system 102. The computing system 108 may be configured to operate the laser heating system 102 to modify interfacial temperatures of the substrate to control grain size, growth, and/or structure of the metal forming the part 118.

The laser heating system 102 of the 3D printer 100 may include one or more lasers 144 (only a single laser 144 is illustrated for simplicity). In some embodiments, the laser(s) 144 are coupled with the ejector head 104 via a mount (not shown). However, the laser(s) 144 and/or the laser heating system 102 may be coupled with any other component of the 3D object printer 100, such as the build platform 106. The laser(s) 144 are configured to direct a laser beam onto the substrate 116 to thereby heat the substrate 116 or a portion thereof.

The laser(s) 144 of the laser heating system 102 may include any suitable laser type that is configured to sufficiently heat the substrate 116. The type of the laser(s) 144 used may be at least partially dependent on the build material, such as the type of metal being deposited to fabricate the article 118, and a rate at which the drops are deposited on the substrate 116, i.e., the deposition rate. In some embodiments, the laser(s) 144 include a fiber laser. For example, commercially available 1070 nm fiber lasers can provide high power, low divergence beam, beam profile shaping, and CW/Pulse modulation. A 1070 nm, 0.5 mm diameter fiber laser beam has a depth of focus of 168 mm or more.

In some embodiments, the laser(s) 144 may have an irradiance of from about 1 W/cm2 to about 10,000 W/cm2. It should be appreciated that much lower power lasers or laser arrays could also be used depending on the application, metal, configuration and spot size. It should further be appreciated that any one or more of the lasers 144 may include a combination of power and optical configurations, including collimated and non-collimated lasers, that may achieve the desired irradiance levels.

The computing system 108 is configured to operate the laser heating system 102 to heat at least a portion of the substrate 116, which may include a portion of the platen 128 or a portion of the part 118. The laser heating system 102 may heat the portion of the substrate 116 before, during, and/or after deposition of the one or more drops of the molten metal on the substrate 116 and/or an area proximal the substrate 116. For example, the laser heating system 102 may emit pulses of laser light in coordination with ejecting the drops of molten metal.

The laser heating system 102 is configured to heats a target portion of the substrate 116 corresponding to the deposition of melted drops and/or the melt pool, before and/or during the deposition of the drops on the substrate 116. It should be appreciated that the deposition of the drops on the substrate 116 may create or form a melt pool on the substrate 116, and the laser heating system 102 is configured to at least partially modulate (e.g., increase, decrease, alter, etc.) an interfacial temperature or a temperature gradient of the melt pool to thereby control one or more properties of the resulting solid metal forming the part 118. For example, modulating the temperature gradient of the melt pool may allow the 3D object printer 100 to control a grain size, grain growth, grain structure, grain orientation, and/or grain boundaries, of the resulting solid metal forming the part 118. It should be appreciated that metal grain formation, structure, and/or properties (e.g., size, growth, orientation, boundaries, etc.) may at least partially determine one or more mechanical properties of the resulting portion of the part 118. For example, the grain formation and/or structure may at least partially determine a yield stress, ductility, hardness, fatigue life, or combinations thereof, of the resulting solid metal forming the part 118. As such, the laser heating system 102 is configured to at least partially heat the portions of the substrate 116 to thereby controls one or more properties of the solid metal forming the part 118.

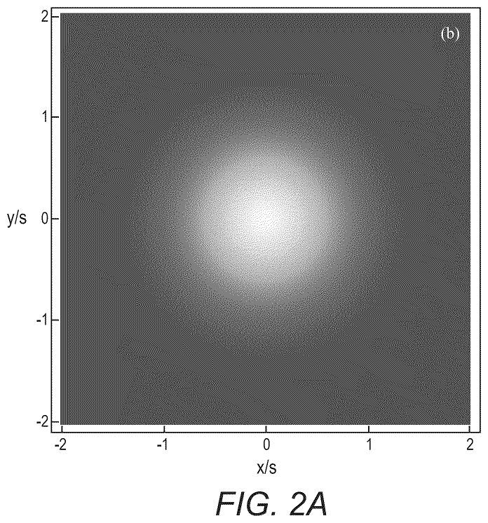

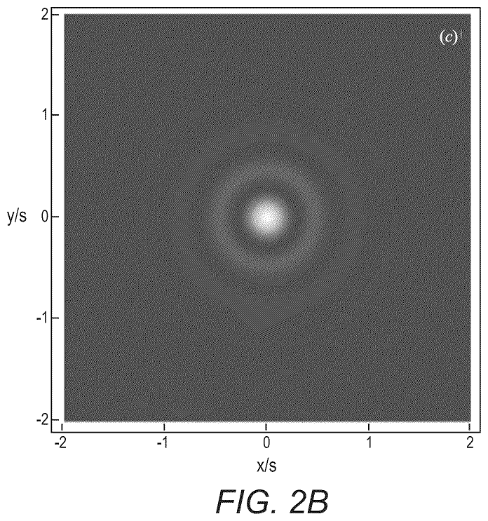

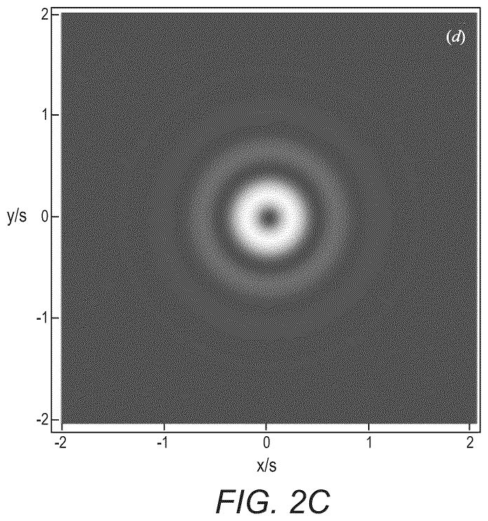

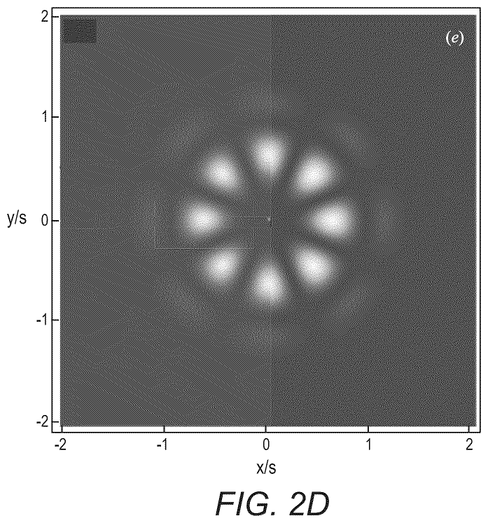

The laser(s) 144 may include optical components like filters, collimating optics, focusing optics and beam shaping optics to achieve specified irradiance levels and beam profiles. The beam profiles may be tailored to profile a specified pattern of heat deposition that is effective for fusing new drops of build material with the existing substrate without deforming the substrate. Example beam profiles are shown and described in relation to FIGS. 2-5.

FIGS. 2A-D depict examples of beam profiles that may be implemented in accordance with certain aspects of the present disclosure. In FIGS. 2A-2D, lighter colored areas are areas of higher light intensity and darker areas are areas of lower light intensity. The x and y coordinates represent positions on the surface of the substrate and are normalized values according to a scaling factor that will vary depending on the actual size of the laser beam footprint. In some embodiments, the laser beam may have a diameter or a major axis from about 0.025 mm to about 1.0 mm. With regard to FIG. 2A, this corresponds with a scaling factor, s, of about 0.025 mm to 1.0 mm.

FIG. 2A depicts a Gaussian beam profile in accordance with certain aspects of the present disclosure. The Gaussian beam profile follows a Gaussian function which may be described as a symmetric bell-shaped curve. For the Gaussian beam profile, the highest intensity will be at the center of the beam (x=0, y=0) and will gradually drop as a function of the distance from the center of the beam. Embodiments of the present techniques use a beam with a non-Gaussian beam profile as shown in FIGS. 2B, 2C, and 2D.

FIG. 2B depicts a ring profile in accordance with certain aspects of the present disclosure. The ring profile beam exhibits rings of increasing and decreasing intensity as a function of the distance from the center of the beam a highest intensity at the center of the beam. In some embodiments, the intensity values of the ring profile beam follow a Bessel function, in which case the beam may be referred to as a Bessel beam, such as a fundamental zero-order Bessel beam. In some embodiments, the Bessel beam profile may be a Gaussian-modulated Bessel beam.

FIG. 2C depicts a hollow-point ring profile in accordance with certain aspects of the present disclosure. The hollow-point ring profile also exhibits rings of increasing and decreasing intensity as a function of the distance from the center of the beam. However, the hollow-point ring profile exhibits a lower light intensity at the center point of the laser beam compared to the highest light intensity of the laser beam. The light intensity at a center point of the laser beam may be any suitable percentage of the highest light intensity, for example, 5, 10, 25, 50, 75 percent of the highest intensity or any value in between. In the example shown in FIG. 2C, the intensity at the center of the beam is identically zero. As in FIG. 2B, the intensity values of the hollow-point ring profile may follow a Bessel function, in which case the beam may be referred to as a hollow-point Bessel beam or a high-order Bessel beam. The hollow-point ring profile of FIG. 2C may be radially (i.e., azimuthally) polarized.

FIG. 2D depicts an azimuthally variable beam profile in accordance with certain aspects of the present disclosure. The beams of FIGS. 2A-C are circularly symmetrical about the beam center. The beam of FIG. 2D is azimuthally variable and therefore not circularly symmetrical. More specifically, the beam of FIG. 2D includes a plurality of lobes arranged about the center point of the beam. Although eight lobes are shown in FIG. 2D, a beam implemented in accordance with embodiments may include any suitable number of lobes.

The beam profiles shown in FIGS. 2A-D may be achieved through any suitable technique, including the use of passive optical components, dynamic optical techniques, or a combination thereof. Passive optical components may include lenses, mirrors, prisms, and/or optical filters, which may be disposed in the path of the laser beam, e.g., at the output of a fiber optic cable. Dynamic optical techniques include phased-array optics, wherein two or more beams may be combined to generate a combined beam with the desired beam profile. In such embodiments, the beam profile may be controlled by controlling the relative amplitude and phase of the combined beams. The use of dynamic optical technique may enable the beam profile to be adjusted during a print job.

It will be appreciated that these beam profiles are only examples, and that various other beam profiles may be implemented depending on the details of a particular implementation. Additionally, although the laser beams are shown as circular, it will be appreciated that the shape of the laser beams will be affected by the angle of incidence of the laser beam. Accordingly, in some implementations, the laser beams as projected onto the surface of the substrate may be elongated (e.g., elliptical) compared to what is shown.

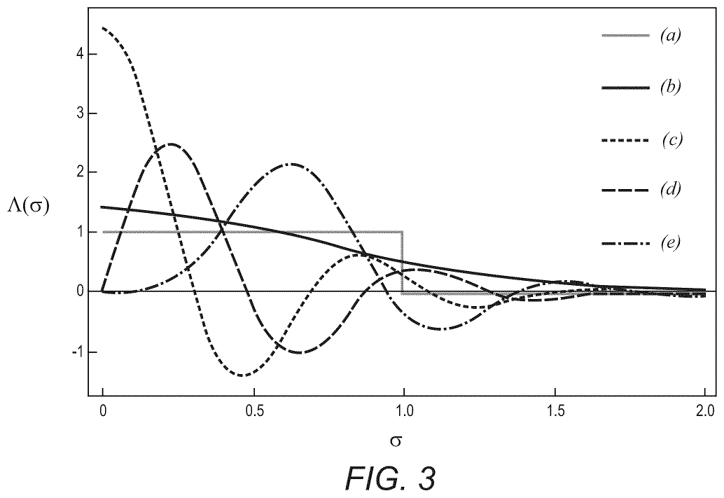

FIG. 3 is a graph of beam magnitude as a function of distance from the beam center in accordance with certain aspects of the present disclosure. In FIG. 3, the Y-axis represent the electric field magnitude, 11, of the laser beam, which corresponds with the light intensity (light intensity is the square of the electric field magnitude), and the X-axis represents the normalized distance, o, from the center of the beam. Each plot represents a different beam profile. Specifically, line A represents a profile referred to herein a top hat profile, which has a value of one from the beam center (σ=0) to σ=1 and then steps to zero for σ>1. Line B represents the Gaussian beam profile of FIG. 2A, line C represents the ring profile of FIG. 2B, line D represents the hollow-point ring profile of FIG. 2C, and line E represents the azimuthally variable beam profile of FIG. 2D.

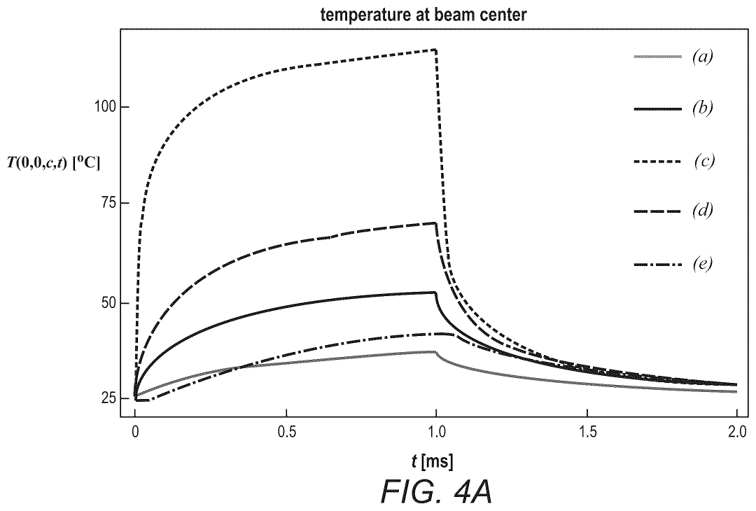

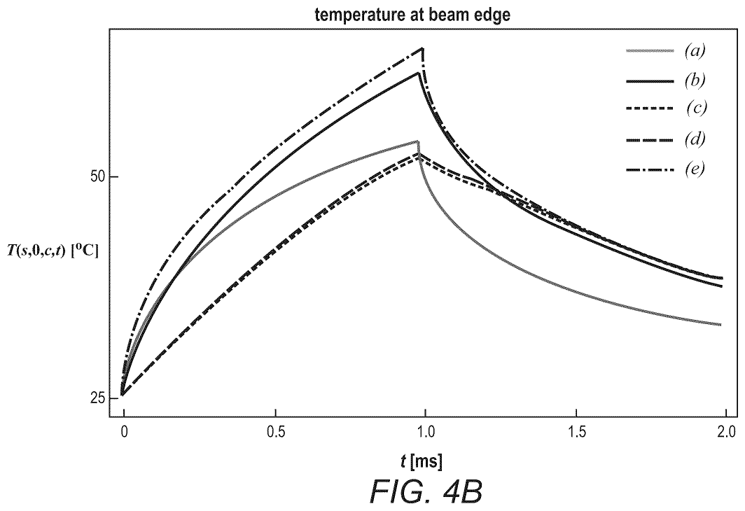

FIGS. 4A and 4B are graphs of substrate temperature as a function of time in accordance with certain aspects of the present disclosure. More specifically, FIG. 4A is a graph of substrate temperature at the beam center as a function of time, and 4B is a graph of substrate temperature at the beam edge (σ=1) as a function of time. As in FIG. 3, line A represents the top hat profile, line B represents the Gaussian beam profile of FIG. 2A, line C represents the ring profile of FIG. 2B, line D represents the hollow-point ring profile of FIG. 2C, and line E represents the azimuthally variable beam profile of FIG. 2D. The Y-axis represents temperature in degrees Celsius, and the X-axis represents time. The time between t=0 and t=1 millisecond (ms) is the time that the beam is on, and the time after t=1 ms represents the time that the beam is off. The total energy emitted is the same for each of the depicted beam profiles.

As shown in FIG. 4A, the temperature at the center of the beam varies significantly depending on the beam profile despite each of the beams having the same total amount of energy. For each of the beam profiles B to E, the temperature at the beam edge tends to remain higher for longer compared to the top hat beam profile. Additionally, the two ring profiles C and D maintain a high edge temperature comparable to the Gaussian beam profile for times past 1 ms (beam off), while having a much lower edge temperature comparable to the Gaussian beam profile for times less between 0 and 1 ms (beam on). Thus, the temperature consistency over time is better for the Bessel beam profiles. Accordingly, it can be seen that the heating profile can be tailored to meet specific criteria by changing the beam profile.

It will be appreciated that the depicted temperatures and times are examples of a single pulse of a light beam. In an actual embodiment, the temperatures may vary from what is shown depending on the implemented beam intensity, the beam pulse duration, and the type of material used for the substrate, among other factors.

In some embodiments, the computing system 108 is configured to operate the laser heating system 102 such that areas of the substrate 116 in the vicinity of a newly added drop of build material are maintained at a temperature of from about 200° C. to about 600° C. In some embodiments, the computing system 108 is configured to operate the laser heating system 102 such that areas of the substrate in the vicinity of a newly added drop of build material are maintained at a temperature of at least about 60% to about 100% of a melting point of the build material. In another example, the laser heating system 102 is configured to increase a temperature of the substrate 116 to about +10% of a melting point of the build material. The temperature levels may be controlled by varying the laser beam intensity, and the duration, frequency, and/or duty cycle of the laser beam pulses.

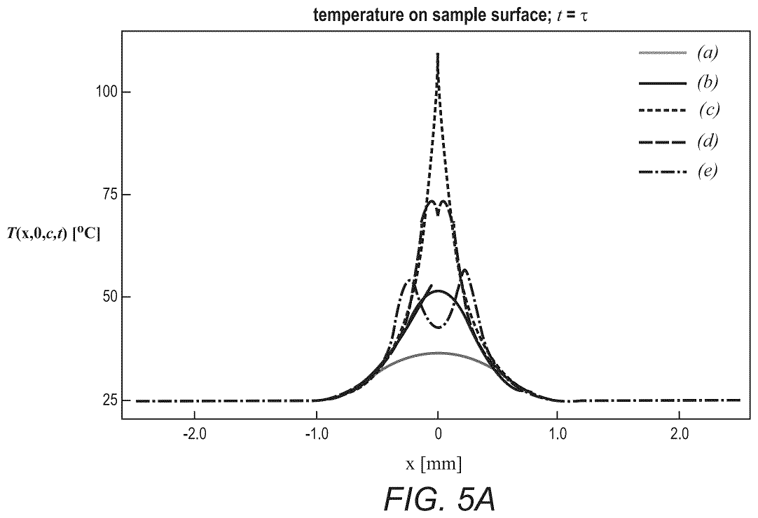

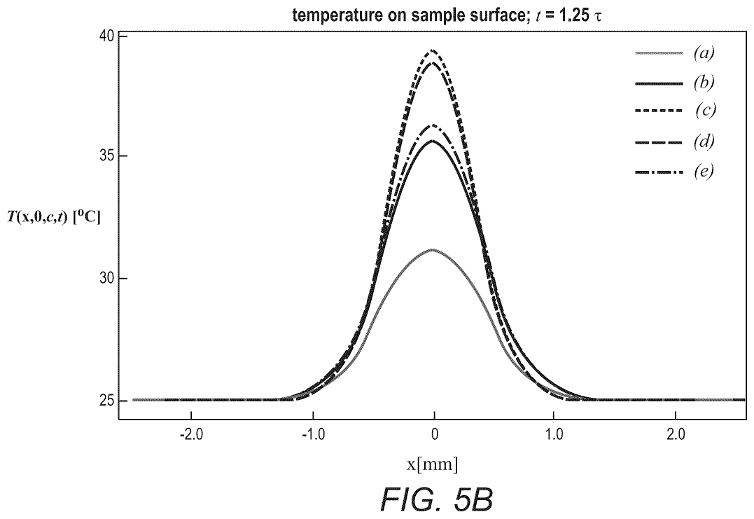

FIGS. 5A and 5B are graphs of the temperature at the substrate's surface in accordance with certain aspects of the present disclosure. FIG. 5A is the temperature at the surface of the substrate at time t=t, where t is the exposure duration. FIG. 5B is the temperature at the surface of the substrate at time t=1.25t, i.e., 0.25 ms after the beam has been turned off. As in FIGS. 3 and 4, line A represents the top hat profile, line B represents the Gaussian beam profile of FIG. 2A, line C represents the ring profile of FIG. 2B, line D represents the hollow-point ring profile of FIG. 2C, and line E represents the azimuthally variable beam profile of FIG. 2D.

As shown in FIGS. 5A, the temperature at the center of the beam is highest for the ring profile beam, but this temperature drops steeply at distances progressively further away from the center of the beam. The hollow-point ring profile has a lower peak temperature at the center and slightly higher temperatures near the beam edges compared to the ring profile of FIG. 2B. The azimuthally variable beam exhibits the more uniform temperature profile across the surface of the substrate compared to the other beams. Specifically, azimuthally variable beam exhibits a bowl-like shape, with peaks temperatures at about 0.2 mm and −0.2 mm and a lower temperature at the beam center. As shown in FIG. 5B, the heat eventually diffuses toward the beam center, eliminating the temperature drop at the center of the beam. The overall result is a more uniform heating pattern across the substrate that lasts for a longer amount of time compared to the other beam profiles.

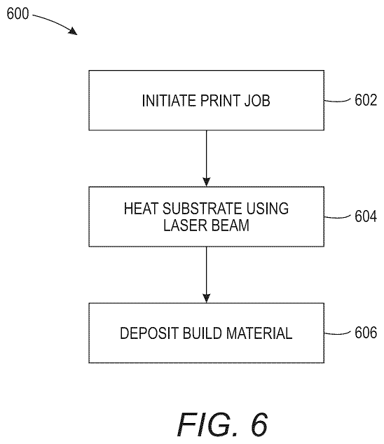

FIG. 6 is a process flow diagram of an example method 600 of operating a 3D printer in accordance with certain aspects of the present disclosure. The method 600 may be performed by the 3D printer 100 of FIG. 1. For example, the method 600 may be performed by the computing system 108, which controls operation of the 3D printer 100 through computer-readable instructions. The method 600 is an iterative method that may be used to fabricate a 3D object through additive manufacturing. The method may begin at block 602.

At block 602, a print job is initiated. The print job is to print a 3D object through any suitable type of additive manufacturing system, such as the 3D printer 100 of FIG. 1 and others.

At block 604, the substrate is heated using a laser beam. The substrate may be a build platform (e.g., platen 128) or an unfinished 3D part (e.g., partially fabricated part 118) being manufactured. The substrate may be heated using a laser beam that exhibits a non-Gaussian pattern, including any of the beam profiles described above. The laser beam may be a pulsed laser beam. The intensity of the laser light and the characteristics of the pulses (e.g., frequency, duty cycle) can be controlled to determine the temperature of the substrate. The pattern of heat distribution across the surface of the substrate may be determined, in part, based on the shape of the laser beam profile. The light intensity, pulse characteristics, and laser beam profile may be adjusted during the print job to adjust to monitored conditions.

At block 606, build material is deposited. As described in relation to FIG. 1, depositing build material may involve depositing a drop of molten metal. However, other types of build material may be used, such as molten polymer, liquid polymer, and others. Additionally, the build material may be deposited through an inkjet process, extrusion process, and others. The heating provided by the laser light at block 604 heats the substrate to provide a strong bond between the deposited build material and the previously deposited build material. Blocks 602, 604, and 606 may be repeated until the part is fully fabricated.

It will be appreciated that the method 600 is a simplified description of a method of fabricating a 3D object, and that additional operations may be performed, such as movement of the build platform, monitoring of the printing process, etc. Various operations are described as multiple discrete operations, in turn, in a manner that is most helpful in understanding the present disclosure, however, the order of description may not be construed to imply that these operations are necessarily order dependent. In particular, the operations shown in FIG. 6 need not be performed in the order of presentation.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof.

What is claimed is:

1. A three-dimensional (3D) printer, comprising:
a platen having a surface to support a part during fabrication of the part;
an ejector head arranged above the surface of the platen, the ejector head to eject build material toward the surface of the platen to fabricate the part; and
a laser heating system to heat a target portion of the part during the fabrication of the part to improve a bond between the build material and the target portion of the part, wherein the laser heating system includes a laser to output a laser beam that exhibits a non-gaussian beam profile.

2. The 3D printer of claim 1, wherein the ejector head is to heat the build material to a molten build material.

3. The 3D printer of claim 1, wherein the build material is a molten metal.

4. The 3D printer of claim 1, wherein the non-gaussian beam profile is a circularly symmetrical beam profile.

5. The 3D printer of claim 1, wherein the non-gaussian beam profile is an azimuthally variable beam profile.

6. The 3D printer of claim 5, wherein the azimuthally variable beam profile comprises a plurality of lobes.

7. The 3D printer of claim 1, wherein the non-gaussian beam profile exhibits a lower light intensity at a center point of the laser beam compared to a highest light intensity of the laser beam.

8. The 3D printer of claim 1, wherein the non-gaussian beam profile is a Bessel beam profile.

9. The 3D printer of claim 1, wherein the non-gaussian beam profile is a hollow-point Bessel beam profile.

10. The 3D printer of claim 1, wherein the non-gaussian beam profile is adjustable during the fabrication of the part.

11. A method of 3D printing a part comprising:
heating a target portion of a surface of a 3D printed part with a laser; and
depositing build material in a vicinity of the target portion;
wherein a laser beam emitted by the laser exhibits a non-gaussian beam profile to control a heating pattern generated by the laser beam on the surface of a 3D printed part.

12. The method of claim 11, wherein depositing the build material comprises ejecting drops of molten metal.

13. The method of claim 12, wherein heating the target portion of the surface of the 3D printed part comprises emitting pulses of laser light in coordination with ejecting the drops of molten metal.

14. The method of claim 11, wherein the laser beam has a circularly symmetrical beam profile.

15. The method of claim 11, wherein the laser beam has an azimuthally variable beam profile.

16. The method of claim 11, wherein the laser beam has a ring profile with rings of increasing and decreasing intensity as a function of distance from a center of the laser beam.

17. The method of claim 16, wherein the ring profile is a hollow-point ring profile.

18. A laser heating system for a 3D printer, comprising:
a laser to heat a target portion of a part during fabrication of the part by the 3D printer to improve a bond between build material ejected by the 3D printer and the target portion of the part, wherein the laser is to output a laser beam that has a non-gaussian beam profile.

19. The laser heating system of claim 18, wherein the laser beam has an azimuthally variable beam profile.

20. The laser heating system of claim 18, wherein the laser beam has a ring profile with rings of increasing and decreasing intensity as a function of distance from a center of the laser beam.
